(19) United States
(12) Patent Application Publication
(10) Pub. No.: US 2006/0191695 A1
(43) Pub. Date: Aug. 31, 2006

(54) Wheel lift assist frame for strip tilling

(75) Inventors: Mark Walker, Nicholls, GA (US); Barton Walker, Nicholls, GA (US); Drew Walker, Nicholls, GA (US); Richard R. Anderson, Cloverdale, OH (US); William C. Maenle, Ottoville, OH (US); David R. Smith, Fort Jennings, OH (US)

Correspondence Address: ROTHWELL, FIGG, ERNST & MANBECK, P.C., 1425 K STREET, N.W., SUITE 800, WASHINGTON, DC, 20005, US

(73) Assignee: Unverferth Manufacturing Co., Inc., Kalida, OH (US)

(21) Appl. No.: 11/066,547

(22) Filed: Feb. 28, 2005

(51) Int. Cl. A01B 63/00

(52) U.S. Cl. 172/452

(57) ABSTRACT

A wheel lift-assist frame comprises a pair of support beams, which may be coupled with a tillage machine at first ends, each beam to the left or right of the center of the tillage machine respective and running rearward of the tillage machine. The support beams may also be coupled with a planter. A cross beam is coupled with the support beams at second ends thereof. A plurality of wheel assemblies are fixed to the cross beam at points such that the wheels run between rows created by the tillage machine.

### BACKGROUND OF THE INVENTION

1. Field of the Invention

The present invention is directed tillage products, and in particular, to a caster wheel lift assist frame.

2. Description of the Related Art

Strip tillage involves preparing a narrow band of a field (i.e., a strip) using a combination of ground engaging shanks, coulters, angled disks, and other devices. This strip may vary in width depending upon the soil type, crop residue that may be above ground, and the crop selected to be planted. In order to improve on operating efficiency, it has become common to couple a tillage tool with a seeding device (e.g., planter) and pull this combined machine with a single tractor. The weight of these combined implements often becomes more than what the tractor can safely lift and maneuver.

One solution to overcoming this problem involves supporting the planter by attaching a pair of hydraulic controlled lift assist wheels. Such wheels may fully swivel and sit behind the planter at the very rear of the combined machine. However, these machines have become so large, both in width and weight, that they cannot be adequatly supported with only two hydraulic controlled lift assist wheels. Further, supporting a machine with simply two wheel adds the problem of sinking into the soil.

Therefofore, there is a need for an improved lift assist wheel system for a combination strip tillage/planting machine. Such systems should include lift assist wheels that run between the rows and that provide greater flotation and lateral stability.

### SUMMARY OF THE INVENTION

According to an embodiment of the present invention, a wheel lift-assist frame is provided. The wheel lift-assist frame has a bracket mountable to a frame at the rear of a tillage machine for attaching a first and a second support beam. The bracket may allow a first end of each of the support beams to be locked in a rigid position or to rotate freely about a bracket pivot. The first and second support beam may extend rearward from the tillage machine and are connectable to a main frame of the planter, one to the left and right of a centerline of the planter respectively. A cross tube or beam may connect second ends of each of the support beams laterally to form a support frame.

First and second caster wheel assemblies including hydraulically controlled 4-bar linkages for vertical movement of the caster wheels can be mounted to the second ends of each of the support beams to run in the row space between the rows made by the tillage machine. A third caster wheel assembly may mount to the cross beam offset substantially outboard or inboard from one of the first or second caster wheel assemblies. The degree of offset may allow clearance for complete swivel rotation of all of the caster wheel assemblies.

Similarly, a fourth caster wheel assembly may mount to the cross beam offset substantially outboard or inboard from one of the first second or third caster wheel assemblies. The degree of offset may also allow clearance for complete swivel rotation of all of the caster wheel assemblies. The cross tube may allow adjustment of the spacing between the caster wheel assemblies to fit a range of row spacings.

According to another embodiment, a wheel lift-assist frame for a combined tillage and planter machine comprises first and second support beams attachable to a tillage machine at first ends thereof. The first and second support beams each including a means for coupling with a frame of a planter. The wheel lift-assist frame also includes a cross beam coupled with second ends of the first and second support beams to form a support frame. The wheel lift-assist frame also includes first and second wheel assemblies respectively coupled with the first and second support beams at the second ends. The first and second wheel assemblies extend away from first and second support beams in a direction parallel to the first and second supports beams. At least one additional wheel assembly is coupled with the cross beam at a point between the first and second support beams and extends away from the first and second support beams in a direction parallel to the first and second supports beams. Each wheel assembly is positioned to run between rows created by said tillage machine. Preferably, the wheel assemblies are caster wheel assemblies with 4-bar hydraulic linkages.

According to another embodiment of the present invention, a combined strip tillage and planter machine includes a strip tillage machine, a planter, at least two support beams attached at first ends of the beams to a frame of the strip tillage machine and extending rearward of the strip tillage machine. Each of the support beams are also attached to a frame of the planter at a point to the right or left of a centerline of the planter such that the planter trails the tillage machine in use. A cross beam is coupled with second ends of the at least two support beams to form a support frame therewith. At least three wheel assemblies are coupled with the cross beam and extend rearward of the cross beam. The wheel assemblies are coupled at points along the cross beam such that the wheels of the wheel assemblies run between rows created by the strip tillage machine.

### BRIEF DESCRIPTION OF THE DRAWINGS

Further applications and advantages of various embodiments of the present invention are discussed below with reference to the following drawing figures:

FIG. 1 is a side profile view of a planter coupled with a tillage machine;

FIG. 2A a perspective view of a support beam for coupling a planter with a tillage machine;

FIG. 2B is a blow up of the support beam coupling;

FIG. 3 is a side profile view of a support beam and a cross beam for coupling a planter with a tillage machine;

FIG. 4A is a perspective view of a caster-wheel assembly being coupled with the support frame with an extender beam, according to an embodiment of the present invention;

FIG. 4B is a top level view of the assembly of FIG. 4A, further showing hydraulic connections to the caster wheel assembly

FIG. 5 is a top-level view of a planter coupled with a tillage machine according to an embodiment of the present invention;

FIG. 6 is a rear-view of a caster-wheel assembly coupled with a support frame of FIG. 5;

FIGS. 7A and 7B are a schematics of hydraulic systems for a four-wheel, caster-wheel lift assist frame according to the present invention; and

FIGS. 8A-D show several views of a rephrase cylinder according to an embodiment of the present invention.

### DETAILED DESCRIPTION OF THE PREFERRED EMBODIMENTS

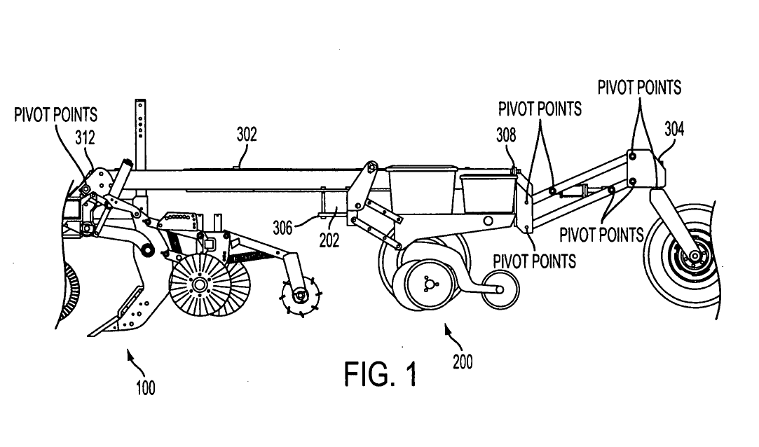

FIG. 1 shows a side view of a combined tillage and planter machine. Planter 200 is coupled with tillage machine 100 via one or more support beams 302. Each support beam 302 is connected to the tillage machine 100 by pivotable, lockable coupling means 312, and to the planter via a clamping means 306. The clamping means 306 may be a conventional clamp, u-bolt, or the like which secures the support beam 302 to a part of the planter frame 202. Caster wheel assemblies 304 are coupled to the support beams 302 at a rear-ward end 308 thereof. The caster wheel assemblies 304 may include hydraulic linkages (here shown as 4-bar) for raising and lowering the planter 200.

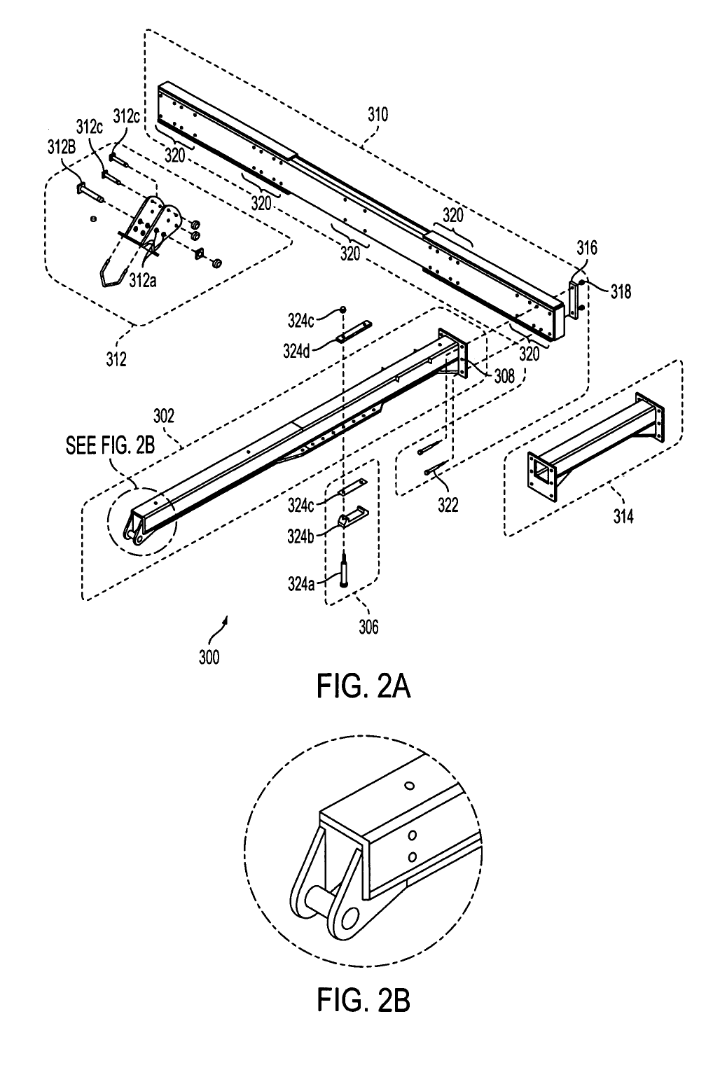

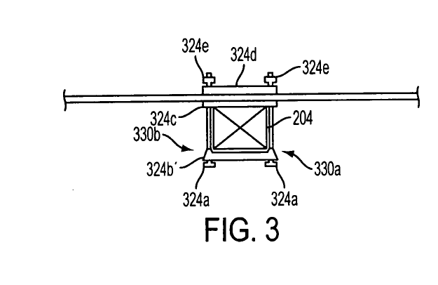

FIGS. 2A and 2B show perspective views of an exemplary support beam assembly. As shown, the coupling means 312 includes joint 312a secured by a bolt 312b, which allows the beam to rotate about the joint 312a. A second bolt 312c is provided to lock the joint in place when desired. The coupling means 312 connects with the end 302a of beam 302, which includes a means 302b for receiving bolt 312b and means 302c for receiving bolts 312c.

Clamping means 306 can include washers or clamping plates 324b and 324c, which can be used to secure the planter frame (not shown) to a flanged portion of the beam 302b which has a number of receptacles for accepting clamping means 306. Support beam 302 may have a flanged end 308 also with a number of receptacles for adjustably coupling with wheel assemblies or a cross beam.

FIG. 2 shows support beam 302 aligned for coupling with cross beam 310. Bolts 322 may be used to couple the two beams, via a plurality of receptacles 320 (e.g., through-holes) in cross beam 310. The plurality of receptacles 320 may be of such number and arrangement to allow adjustment of the point of coupling laterally and also, to allow the caster wheel assemblies (not shown) to be adjustable laterally to run between the rows created by the tillage machine. As shown, four sets of holes 320 are spaced a standard distance from one another across the beam 310, to allow at least four caster wheel assemblies to be coupled thereto.

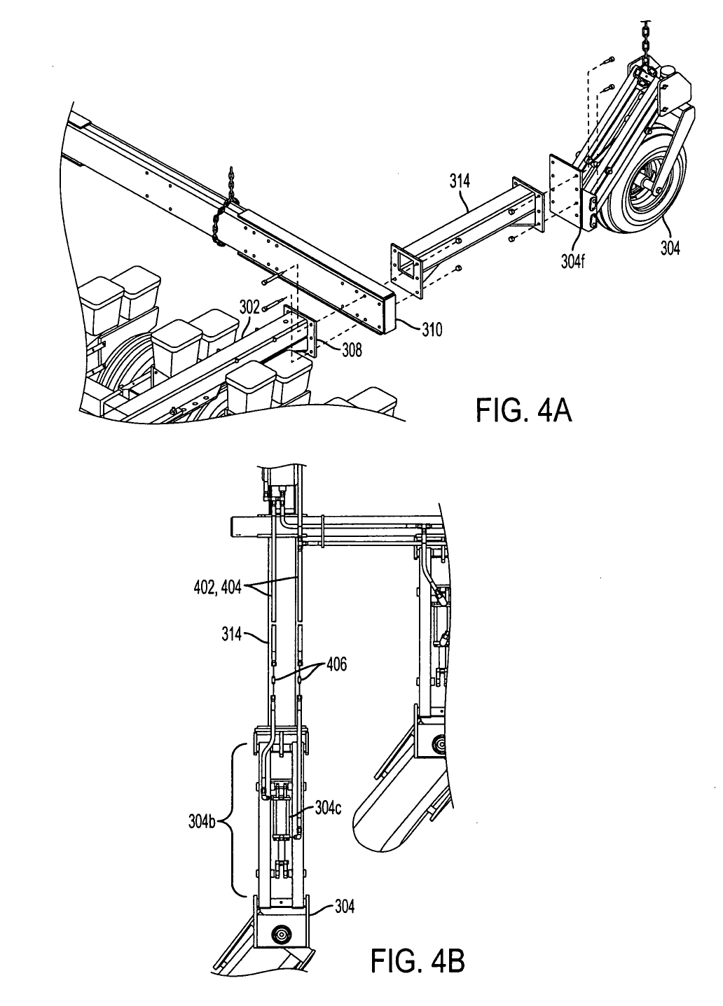

A coupling means is also shown in FIG. 3, according to another embodiment of the present invention. To reduce the amount of loosening of the bolts 324(a,e), a clamp bar 324b′ is provided having raised portions, like wedged ends, 330(a,b) through which the bolts pass (fastening means), such that the portion of the clamp bar 324b′ between the bolts 324a does not contact with the planter section 204 or with another clamp bar or washer 324c. It has been found that the wedged ends 330(a,b) allow the clamp bar to flex and absorb additional stresses during usage of the machines and therefore, prevents the nuts 324e from loosening.

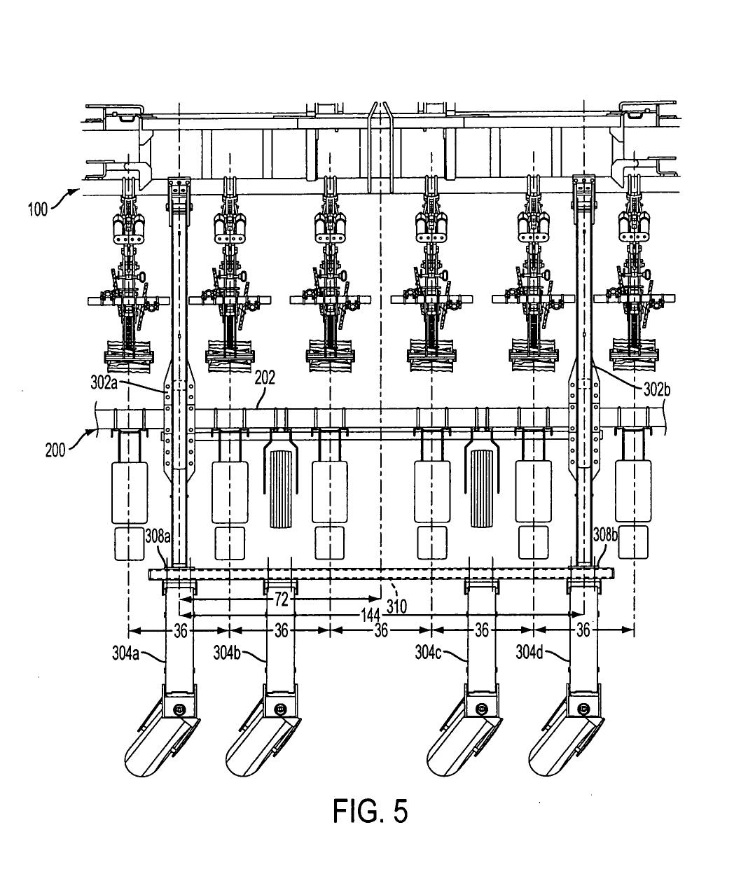

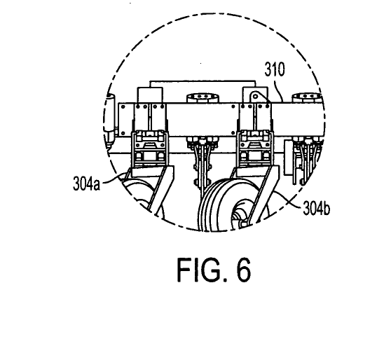

An extender beam 314 is also shown in FIGS. 2 and 4A. The extender beam 314 may have flanged ends with receptacles for adjustably coupling with equipment (e.g., caster wheel assemblies, cross beam 310). As will be described in more detail, the extender beam 314 may be incorporated to move selected caster wheel assemblies 304 rearward to prevent wheels from striking each other during backing or turning.

Referring to FIGS. 4A and 4B, the extender beam 314 is shown along with an exemplary wheel assembly 304. Wheel assembly 304 includes caster wheels that are free to rotate about a center point. As a result, during use, adjacent caster wheels may come in contact during backing or turning. This contact will most likely result during backing, since that is when the wheels may be likely to rotate in different directions. As shown in FIG. 4B, the extender beam 314 may be used to provide more distance between adjacent wheels 304, in order to prevent the wheels 304 from contacting during backing or turning.

One will understand that the wheel assemblies may be offset from one another, either laterally along the cross beam 310 or in the rearward direction by using an extender, to prevent collision between wheels. However, because the wheels should be position to run between the rows created by the tillage machine, it may be more practical to use the extender beam 314 to offset the wheels in the rearward direction from adjacent wheels.

Hydraulic lines 402, 404 supplying hydraulic fluid to pistons within caster wheel assemblies 304, may be extended over the extender beam 314 and connected to the caster wheel assembly 304 by conventional means 406.

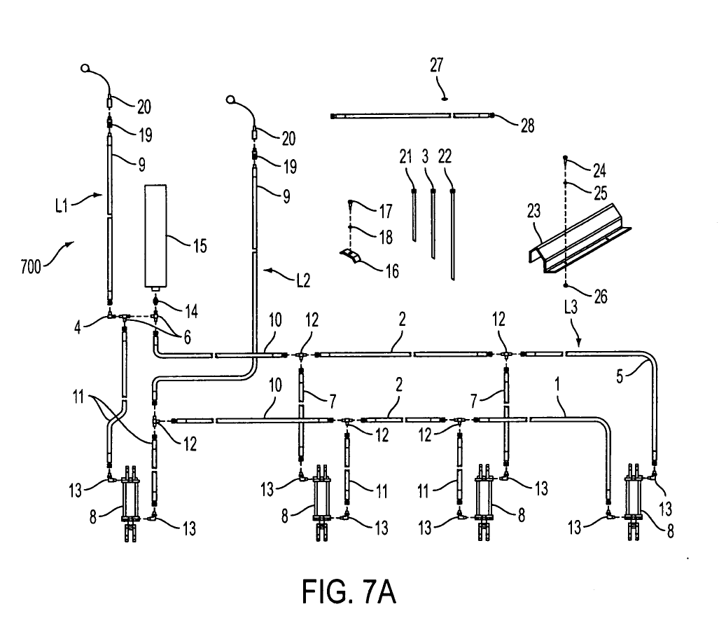

FIG. 5 is a top level view of an exemplary combined tillage and planter machine according to an embodiment of the present invention. As can be seen, two support beams 302a and 302b are attached to the frame of the tillage machine 100. Support beams 302a and 302b are coupled at points left of the center and right of the center of the tillage machine 100, respectively. Support beams 302a and 302b are also coupled with the planter 200, by securing the support beams to a portion of the planter frame 202.

A cross beam 310 is coupled with the support beams 302a, 302b at the rearward ends 308a, 308b, respectively, to form the support frame. Caster wheel assemblies 304a-d may be coupled with the cross beam 310. Preferably, the caster wheel assemblies 304a and 304d are coupled at the point where the support beams 302a and 302b are coupled with cross beam 310, and therefore, are coupled with support beams 302a and 302b, respectively. This provides the frame more strength.

Referring back to FIG. 4A, a flanged portion 304f of the caster wheel support 304 can be aligned with receptacles in the cross beam 310 and in the rearward end 308 of the support beam for coupling. Caster wheel assemblies 304b and 304c are coupled at points on cross beam 310 between support beams 302a and 302b to provide more support to the combined machine. Although not shown, the extender beams 314 may be used to extend any of the wheel assemblies, but preferably the outer assemblies 304a and 304d rather than the middle assemblies 304b and 304c. As shown, the middle assemblies 304b and 304c are a greater distance from each other than adjacent assemblies 304a and 304b, or 304c and 304d. Therefore, when the outer assemblies 304a and 304d are extended in this case, the two assemblies are far enough apart that there is no risk of their wheels colliding. One skilled in the art will understand that if more wheel assemblies are added, then extender beams may be used to stagger adjacent wheel assemblies to avoid collisions between wheels.

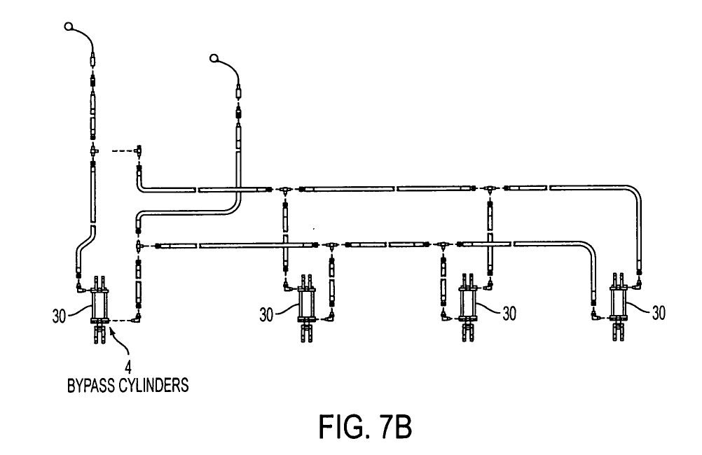

FIG. 6 shows a left hand rear view of the coupling point of wheel assemblies 304a and 304b and beam 310. As shown, a plurality of receptacles may be provided in the beam 310, so that the position where the wheel assemblies are attached to the beam 310 may be adjusted laterally, so that the wheels run between rows created by the tillage machine 100.

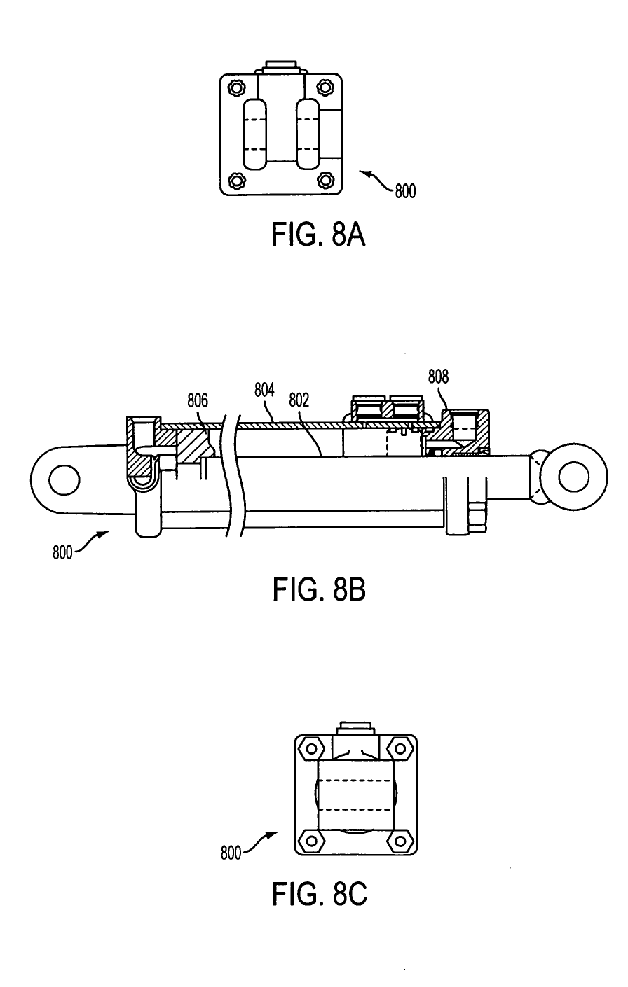

FIG. 7A is a schematic of an exemplary hydraulic system 700 for the caster wheel support frame of the present invention. System 700 includes two lines L1 and L2, comprising a number of tubes and connectors (2-7, 9-14, 16-20) for controlling the amount of fluid in pistons (standard double-acting cylinders) 8, which serve to control the position of caster wheel assemblies 304 (e.g., extended, retracted). Connecting means 20 allow conventional connections to a hydraulic system of a tractor or the like. A third line L3 is connected to one of the pistons at one end and to an accumulator 15 at the other end. The accumulator may be set to maintain a level of fluid in pistons 8 during use. Preferably, the accumulator 15 is preferably preset to maintain a maximum pressure in pistons 8. This will allow more even distribution of the weight of the planter to all four caster wheel assemblies.

FIG. 7B is an alternative hydraulic system. The accumulator 15 is removed and the standard double acting cylinders 8 of FIG. 7A are replaced with rephrase cylinders 30, having a 1-inch float range. The addition of these cylinders 30 eliminates additional plumbing that was required between the accumulator 15 and hydraulic cylinders 8.

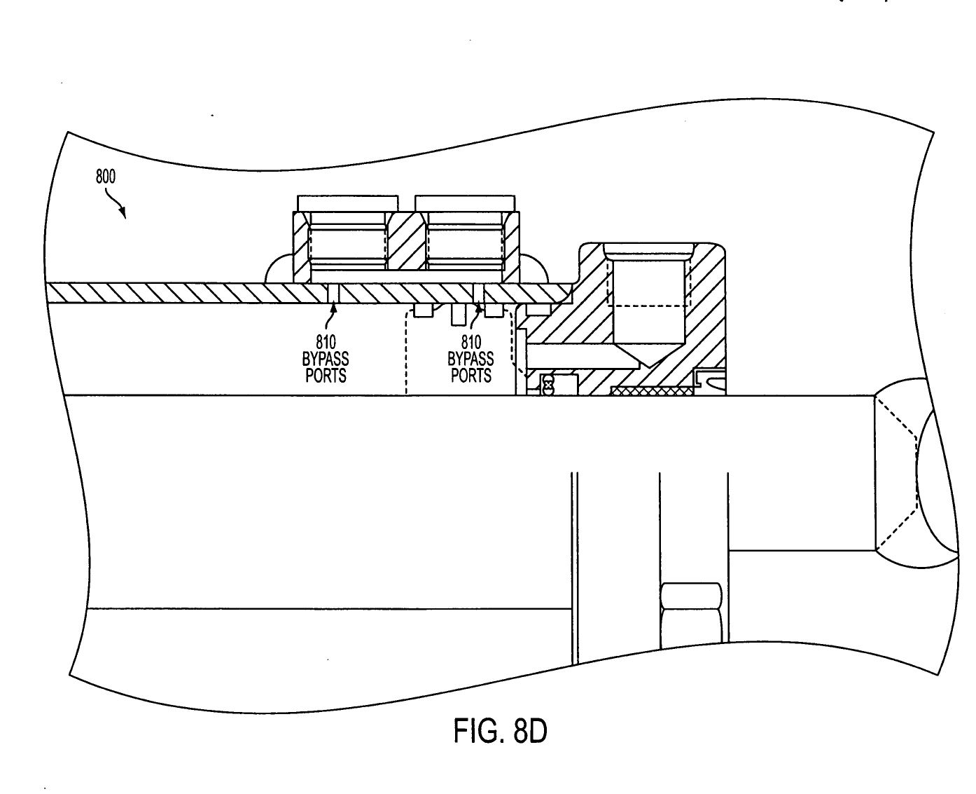

FIGS. 8A-C show respectively, front, side and rear views of an exemplary rephrase cylinder according to an embodiment of the present invention. The cylinders 800 includes a 3-inch diameter cylinder 802 with a 6-inch normal stroke and a total cylinder stroke of 7-inches. The rephrase cylinders 800 are designed to have a total travel of 7-inches with a normal operating length of 6-inches.

Referring to FIG. 8D, the cylinders include built-in bypass ports 810 that allow the last 1-inch of travel of the cylinder to float while the machine is in transport. This bypass action allows hydraulic oil to move from cylinder to cylinder with in the system. The movement of oil allows constant even pressure to be maintained on all wheels at all times. The floating action is accomplished with the hydraulic system because as one wheel encounters increased pressure, such as from an increased load on it, the cylinder will force oil out of it into the rest of the system, causing the cylinder corresponding to the wheel with the least amount of pressure to stroke-out. As a result, oil moves into the bypass segment of the stroke for that cylinder, which causes the system pressure to equalize. Thus, all the wheels maintain even pressure to the road surface.

This hydraulic system can be easily adapted to use with any size and number of cylinders. Further, the cylinder bypass length could also be changed to match the cylinder float requirements of the system.

One skilled in the art will understand the suitable materials to be used for assembling the castor wheel lift-assist frame as described above. For example, steel frame and hardware would provide good strength and protection from corrosion and rust.

The wheel lift-assist frame of the present invention offers greater flotation and lateral stability and support for the planter than one with fewer wheel assemblies. Caster wheels placed outboard along a cross beam with the four-bar linkage arranged to trail the planter may also be more convenient than a comparable four-bar linkage in which a support structure extends laterally. Furthermore, caster wheels located to trail behind the planter will minimize the overall unit width in the field and while transporting from field to field. Finally, caster wheels arranged to trail the planter may apply a moment about the axes of the wheels, shifting the weight of the planter to the tillage machine thereby reducing soil compaction.

Thus, a number of preferred embodiments have been fully described above with reference to the drawing figures. Although the invention has been described based upon these preferred embodiments, it would be apparent to those of skilled in the art that certain modifications, variations, and alternative constructions would be apparent, while remaining within the spirit and scope of the invention.

We claim:

1. A wheel lift-assist frame for a combined tillage and planter machine, comprising:
first and second support beams attachable to a tillage machine at first ends thereof, said first and second support beams each including a means for coupling with a frame of a planter;
a cross beam coupled with second ends of said first and second support beams, forming a support frame;
first and second wheel assemblies respectively coupled with said first and second support beams at said second ends, said first and second wheel assemblies extending away from said first and second support beams in a direction parallel to said first and second supports beams; and
at least one additional wheel assembly coupled with said cross beam at a point between said first and second support beams and extending away from said first and second support beams in a direction parallel to said first and second supports beams;
wherein each said wheel assembly is positioned to run between rows created by said tillage machine.

2. The wheel lift-assist frame as recited in claim 1, further comprising first and second brackets mountable to a frame of a rear of the tillage machine for attaching said first and second support beams thereto, said first and second brackets allowing said first ends of said first and second support beams attached thereto to be locked in a rigid position or to rotate freely about a bracket pivot.

3. The wheel lift-assist frame as recited in claim 1, wherein, when coupled with the tillage machine and planter, the first and second support beams extend rearward from the tillage machine left and right of a centerline of the planter, respectively.

4. The wheel lift-assist frame as recited in claim 1, wherein each said wheel assembly comprises hydraulically controlled 4-bar linkages for vertical movement of the wheels.

6. The wheel lift-assist frame as recited in claim 1, wherein said at least one additional wheel assembly includes a third wheel assembly mounted to the cross tube offset substantially outboard from one of the first or second caster wheel assemblies.

7. The wheel lift-assist frame as recited in claim 6, wherein the degree of offset may allow clearance for complete swivel rotation of all of the caster wheel assemblies.

8. The wheel lift-assist frame as recited in claim 1, wherein said means for coupling include a clamp bar having a shape which prevents loosening of said means for coupling.

9. The wheel lift-assist frame as recited in claim 1, further comprising a common hydraulic system for providing hydraulic fluid to said wheel assemblies.

10. The wheel lift-assist frame as recited in claim 9, wherein said hydraulic system includes a plurality of rephrase cylinders with built-in bypass systems, said rephrase cylinders maintaining pressure on each of said wheels evenly.

11. The wheel lift-assist frame as recited in claim 9, wherein said common hydraulic system comprises an accumulator.

12. The wheel lift-assist frame as recited in claim 1, wherein said at least one additional wheel assembly includes third and fourth wheel assemblies mounted to the cross tube offset substantially outboard from said first or second caster wheel assemblies, respectively.

13. The wheel lift-assist frame as recited in claim 12, wherein the degree of offset may allow clearance for complete swivel rotation of all of the wheel assemblies.

14. The wheel lift-assist frame as recited in claim 12, wherein each said wheel assembly comprises hydraulically controlled 4-bar linkages for vertical movement of the wheels.

15. The wheel lift-assist frame as recited in claim 14, further comprising first and second extender beams coupled with said first and second support beams and extending rearward, wherein said first and second wheel assemblies are coupled with rearward ends of said first and second extender beams respectively.

16. A combined strip tillage and planter machine, comprising:
a strip tillage machine;
a planter;
at least two support beams attached at first ends of said beams to a frame of said strip tillage machine and extending rearward of said strip tillage machine, each of said support beams also being attached to a frame of said planter at a point to the right or left of a centerline of said planter such that said planter trails said tillage machine in use;
a cross beam coupled with second ends of said at least two support beams to form a support frame therewith; and
at least three wheel assemblies coupled with said cross beam and extending rearward of said cross beam, said at least three wheel assemblies being coupled at points along said cross beam such that the wheels of the wheel assemblies run between rows created by said strip tillage machine.

17. The machine as recited in claim 16, further comprising a plurality of brackets mountable to said frame of the strip tillage machine for attaching said at least two support beams thereto, said first and second brackets allowing said first ends of said first and second support beams attached thereto to be locked in a rigid position or to rotate freely about a bracket pivot.

18. The machine as recited in claim 16, wherein first and second support beams of said at least two support beams are attached to the tillage machine and the planter, the first and second support beams extending rearward from the tillage machine left and right of a centerline of the planter, respectively.

19. The machine as recited in claim 16, wherein each said wheel assembly comprises hydraulically controlled 4-bar linkages for vertical movement of the wheels.

20. The machine as recited in claim 16, wherein each of said wheel assemblies are offset from adjacent wheel assemblies to allow clearance for complete swivel rotation of the wheels of the wheel assemblies.

21. The machine as recited in claim 16, further comprising a coupling means for attaching each said support beam to the frame of said planter, said coupling means including a clamp bar having a shape which prevents loosening of said coupling means.

22. The machine as recited in claim 21, wherein said clamp bar has a first surface which is flat and a second surface opposite of said first surface, said second surface having raised portions, and holes through said clamp bar from said first surface to said second surface, said holes being made in the raised portions of the second surface.

23. The machine as recited in claim 16, further comprising a clamp for attaching each said support beam to the frame of said planter, said clamp including a clamp bar having a first surface which is flat and a second surface opposite of said first surface, said second surface having raised portions, and receptacles through said clamp bar at said raised portions, and tensioning means for securing said clamp bar to one of said support beams.

24. The machine as recited in claim 19, further comprising a common hydraulic system for each of said at least three wheel assemblies, said common hydraulic system including an accumulator that maintains constant pressure to each of said wheel assemblies.

25. The wheel lift-assist frame as recited in claim 24, wherein said hydraulic system includes a plurality of rephrase cylinders with built-in bypass systems, said rephrase cylinders maintaining pressure on each of said wheels evenly.

26. The machine as recited in claim 16, wherein said at least three wheel assemblies includes first or second caster wheel assemblies respectively coupled to said first and second support beams, and third and fourth castor wheel assemblies mounted to the cross tube between said first and second castor wheel assemblies, offset substantially from said first or second caster wheel assemblies, respectively.

27. The machine as recited in claim 26, wherein the degree of offset may allow clearance for complete swivel rotation of all of the wheel assemblies.

28. The machine as recited in claim 26, further comprising first and second extender beams coupled with said first and second support beams and extending rearward of said cross beam, wherein said first and second castor wheel assemblies are coupled with rearward ends of said first and second extender beams respectively.

29. A wheel lift support frame for coupling a strip tillage machine with a planter, comprising:
a U-shaped support frame having first and second sides and a bottom section, said support frame mountable onto a frame of the planter at midpoints on the first and second sides of the frame and attachable to a rear-frame of the tillage machine at endpoints of first and second sides of the support frame; and
a plurality of lift wheels attached to the bottom section of the support frame and spaced from one another along the bottom section to run between rows created by the tillage machine.

30. The wheel lift support frame as recited in claim 29, wherein said plurality of lift wheels comprise hydraulic powered castor wheel assemblies, and said wheel lift support frame further comprises a hydraulic system coupled with each said hydraulic powered castor wheel assembly and including at least one accumulator, said hydraulic system connectable with a hydraulic system of a tractor.

31. The wheel lift support frame as recited in claim 29, further comprising at least one extension piece for offsetting at least one wheel assembly rearward of said frame.

32. The wheel lift support frame as recited in claim 29, further comprising a plurality of brackets mountable to said rear frame of the strip tillage machine for attaching said endpoints of first and second sides of the support frame thereto, said first and second brackets allowing said endpoints of first and second sides to be locked in a rigid position or to rotate freely about a bracket pivot.

33. The wheel lift support frame as recited in claim 29, wherein each of said wheel assemblies are offset from adjacent wheel assemblies to allow clearance for complete swivel rotation of the wheels of the wheel assemblies.

34. The wheel lift support frame as recited in claim 29, wherein said bottom portion of said support frame has a plurality of receptacles for adjusting a position of each said wheel assembly laterally, along said bottom portion.

35. The wheel lift support frame as recited in claim 29, further comprising a coupling means for attaching the frame of the planter to midpoints on the first and second sides of the support frame, said coupling means including a clamp bar having a shape which prevents loosening of said coupling means.

36. The wheel lift support frame as recited in claim 29, wherein said first and second sides of the support frame include flanged portions for attaching the frame of the planter to the first and second sides of the support frame.

37. A method for combining a tillage machine and a planter, comprising steps of:
providing first and second support beams each having first and second ends;
attaching first ends of the first and second support beams to a rear frame of a tillage machine such that the first and second support beams are aligned perpendicular to and rearward of said rear frame;
attaching said first and second support beams to a top frame of a planter, said planter being aligned to trail said tillage machine and being attached at a point between said first and second ends of each support beam, such that said first and second support beams being attached left and right of a centerline of said planter respectively and that said second ends of said first and second support beam extend past the rearward end of the planter;
attaching said second ends of said first and second support beams with a third support beam;
attaching a plurality of wheel lift assemblies to said third support beam such that said wheel lift assemblies extend rearward of said third support beam and will run between rows created by said tillage machine.

38. The method of claim 37, wherein the step of attaching the first and second support beams to the rear frame of the tillage machine include attaching brackets to said rear frame, said brackets being adjustable to hold the first ends of the first and second support beams rigid or to allow said first ends to rotate freely about a pivot parallel to said rear frame.

39. The method of claim 37, wherein the step of attaching said first and second support beams to a top frame of a planter includes a step of fastening the top frame of the planter to the support beams with a U-bolt.

40. The method of claim 37, further comprising a step of providing a hydraulic system for controlling an amount of lift by said wheel lift assemblies and a step of providing an accumulator within said hydraulic system for maintaining pressure to all of said wheel lift assemblies.

41. The method of claim 37, further comprising a step of providing a hydraulic system for controlling an amount of lift by said wheel lift assemblies, said hydraulic system being configured to maintain the amount of lift by said wheel lift assemblies to be substantially the same for each of said wheel lift assemblies.
